(19) United States
(12) Patent Application Publication
(10) Pub. No.: US 2008/0137006 A1
(43) Pub. Date: Jun. 12, 2008

(54) PORTABLE ELECTRONIC DEVICE WITH DISPLAY PANEL

(75) Inventor: JEN-TSORNG CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/837,457

(22) Filed: Aug. 10, 2007

(30) Foreign Application Priority Data
Dec. 8, 2006 (CN) 200610157358.0

(51) Int. Cl. G02F 1/13357; F21V 8/00

(52) U.S. Cl. 349/65; 362/612; 362/615; 362/617

(57) ABSTRACT

A portable electronic device (10) includes a first housing (11), a second housing (13), a display panel (17) and a backlight module (19). The first housing (11) has a heat dissipating device (114) therein. The second housing (13) is pivoted to the first housing (11). The display panel (17) is accommodated in the second housing (13). The backlight module (19) includes a light source (192), a light guide plate (196) and an optical fiber assembly (194). The light source (192) is disposed in the first housing (11). The light guide plate (196) is disposed in the second housing (13). The optical fiber assembly (19) includes a plurality of optical fibers interconnecting the light source (192) and the light guide plate (196).

### BACKGROUND

1. Field

The invention relates generally to portable electronic device, and more particularly to a portable electronic device with a display panel.

2. Description of Related Art

Currently, portable electronic devices, such as portable computers, personal digital assistants (PDAs), cellular telephones, etc., are becoming indispensable products for people in modern life. Along with the increasingly widespread use of such devices, there is a demand for developing portable electronic devices with high efficiency. Moreover, miniaturization is also a trend for such products.

Referring to FIG. 4, a conventional notebook computer 20 includes a first housing 21, a second housing 22 and a display device 23. The display device 23 can be a liquid crystal display device, which has a liquid crystal display panel 231 and a backlight module 232. The second housing 22 is pivoted to the first housing 21 with a hinge 24. The first housing 21 has a motherboard 211 and a heat sink 212. At least one electronic element 213, such as a CPU, is mounted on the motherboard 211. The heat sink 212 contacts with the electronic element 213 so as to dissipate the heat generated from the electronic element 213. The display device 23 is accommodated in the second housing 22. The backlight module 232 is disposed behind the liquid crystal display panel 231. The second housing 22 allows a viewer to view the liquid crystal display panel 231.

As mentioned above, the backlight module 232 includes a light source 234 and a light guide device 236. The light source 234 emits light which is guided and spread uniformly by the light guide device 236 to provide uniform illumination to the liquid crystal display panel 231. In general, a cold cathode fluorescent lamp (CCFL) or a plurality of light emitting diodes (LEDs) can be employed as the light source 234. The LEDs are preferable due to their brightness, low operating voltage and long lifespan.

However, the light source 234 with high brightness causes more heat generation accordingly. Additionally, because the second housing 22 accommodating the backlight module 232 is designed to satisfy the miniaturization requirement, there is less space for dissipating the heat generated from the LEDs. Once the heat accumulates, the performance of portable electronic device 20 deteriorates and then the lifespan of portable electronic device 20 is reduced.

What is needed, therefore, is a portable electronic device having better performance in dissipating heat generated from the light source.

### SUMMARY

A portable electronic device is provided. In one present embodiment, the portable electronic device includes a first housing, a second housing, a display panel and a backlight module. The first housing has a heat dissipating device therein. The second housing is attached by a pivot to the first housing. The display panel is accommodated in the second housing. The backlight module includes a light source, a light guide plate and an optical fiber assembly. The light source is disposed in the first housing. The light guide plate is disposed in the second housing. The optical fiber assembly comprising a plurality of optical fibers interconnects the light source and the light guide plate.

Another portable electronic device is provided. In one present embodiment, the portable electronic device includes a display panel, a light guide plate, a plurality of point light sources and a plurality of optical fibers. The light guide plate has a light input surface and a light output surface. The light output surface faces towards the display panel. The optical fibers each has a first end optically coupled to the point light source and an opposite second end optically coupled to the light input surface of the light guide plate.

Advantages and novel features of the present portable electronic device will become more apparent from the following detailed description of preferred embodiments when taken in conjunction with the accompanying drawings.

### BRIEF DESCRIPTION OF THE DRAWINGS

The components in the drawing are not necessarily drawn to scale, the emphasis instead being placed upon clearly illustrating the principles of the present invention.

FIG. 1 is a schematic view of a portable electronic device with a display panel in accordance with a preferred embodiment of the present invention.

FIG. 2 is a schematic exploded view of an optical fiber assembly of FIG. 1.

FIG. 3 is a schematic view of the optical fiber assembly with a plurality of condenser lenses in accordance with the preferred embodiment of the present invention.

FIG. 4 is a schematic view of a conventional portable electronic device.

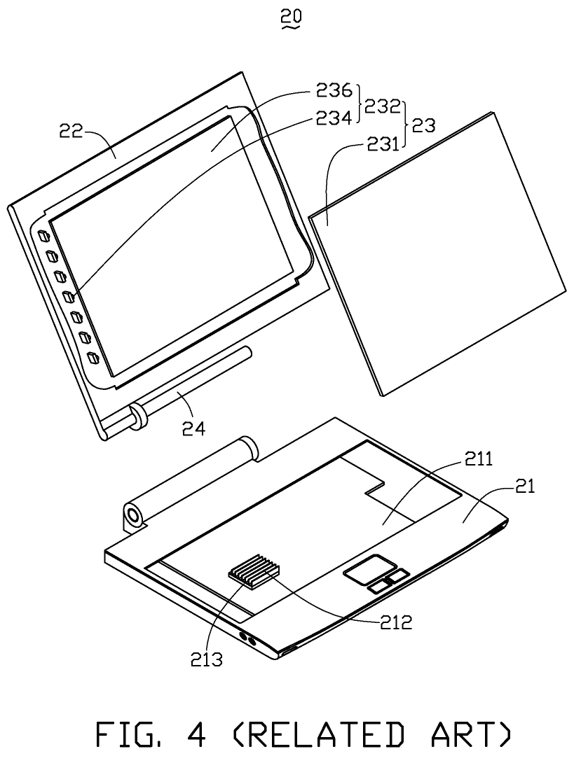

Corresponding reference characters indicate corresponding parts. The exemplifications set out herein illustrate at least one preferred embodiment of the present portable electronic device, in one form, and such exemplifications are not to be construed as limiting the scope of the invention in any manner.

### DETAILED DESCRIPTION OF THE EMBODIMENT

Reference will now be made to the drawings to describe embodiments of the present portable electronic device in detail.

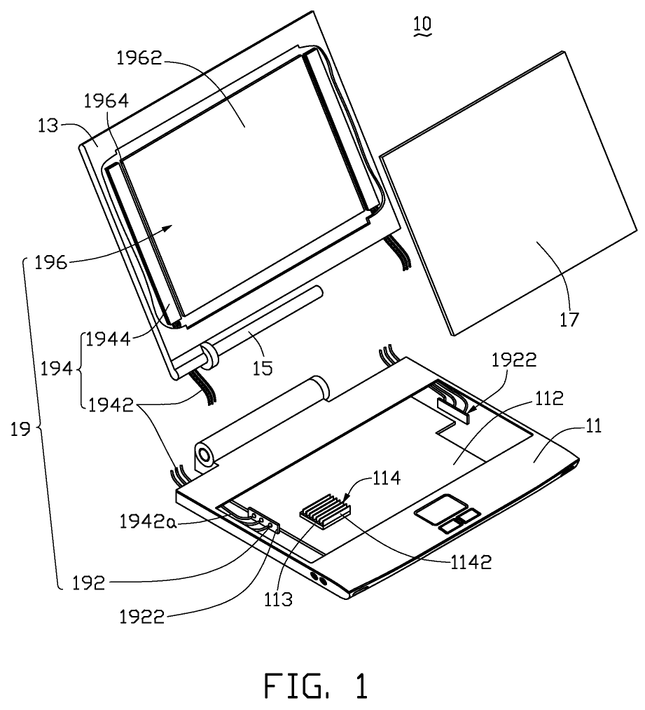

Referring to FIG. 1, a portable electronic device 10 in accordance with a present embodiment, is shown. The portable electronic device 10 includes a first housing 11, a second housing 13, a display panel 17 and a backlight module 19.

The first housing 11 has a motherboard 112 and a heat dissipating device 114 mounted thereabove. The motherboard 112 has at least on electronic element 113, such as a CPU, mounted thereon. The heat dissipating element 114, such as a heat sink, thermally contacts with the electronic element 113 to dissipate the heat generated from the electronic element 113. In the present embodiment, the heat dissipating element 114 is disposed on the electronic element 113 and has a plurality of fins 1142 through which the efficiency of dissipating heat is increased by its large surface.

In the present embodiment, the second housing 13 is connected via a pivot to the first housing 11. In particular, the second housing 13 is connected to the first housing 11 with a hinge 15. The display panel 17 is accommodated in the second housing 13. In such case, the display panel 17 can be, but is not limited to, a liquid crystal display panel or other such display device with a backlight module.

The backlight module 19 is used to provide the needed illumination for the display panel 17. The backlight module 19 includes a light source 192, a light guide plate 196 and an optical fiber assembly 194. The light source 192 is disposed in the first housing 11. The light guide plate 196 is disposed in the second housing 13 and at a rear side of the display panel 17. The optical fiber assembly 194 interconnects the light source 192 and the light guide plate 196. In particular, the optical fiber assembly 194 is configured for transmitting the light emitted by the light source 192 to the light guide plate 196. The light guide plate 196 redistributes the light transmitted by the optical fiber assembly 194 so as to act as a surface light source for illuminating the display panel 17.

The light source 192 can be a point light source (e.g. light emitting diode, LED). In the present embodiment, the portable electronic device 10 employs a plurality of LEDs disposed adjacent to the motherboard 112. In addition, the LEDs are mounted on a printed circuit board (PCB) 1922 used to functionally control LEDs. The PCB 1922 thermally contacts the motherboard 112 so that the heat generated from the LEDs can be dissipated to the surrounding rapidly through the heat dissipating element 114 mounted on the motherboard 112. A plurality of the PCBs 1922 can be disposed at two opposite sides of the motherboard 112, as shown in FIG. 1. Each of the PCBs has an LED array mounted thereon. Alternatively, the light source 192 can be disposed on the motherboard 112 directly. Therefore, due to a relatively larger dissipating space on the first housing for dissipating heat and thermally contacting the light source 192 with the heat dissipating element 114, the heat generated from the light sources 192 can be dissipated effectively. As a result, heat accumulation in the portable electronic device 10 is avoided so that the portable electronic device 10 can maintain optimal work temperatures.

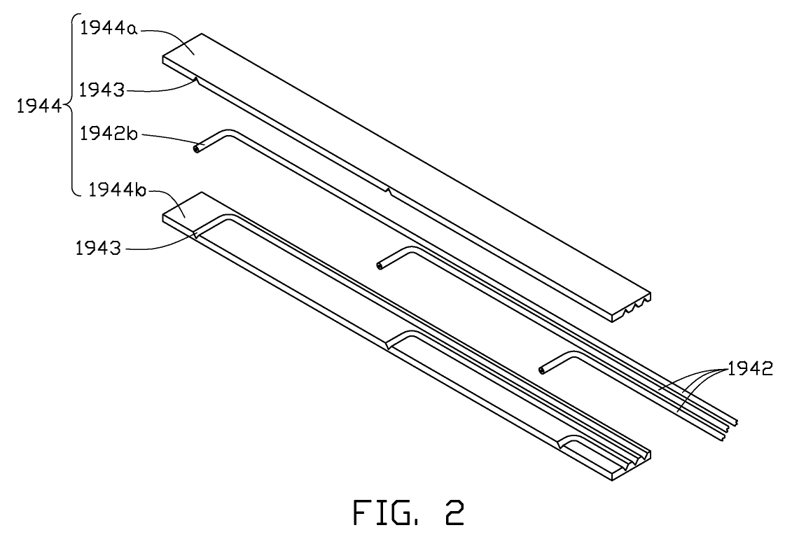

The optical fiber assembly 194 includes optical fibers 1942 and a retaining element 1944. In the present embodiment, the optical fibers 1942 can be plastic optical fibers or glass optical fibers used to transmit visible light. As shown in FIG. 1 and FIG. 2, each of the optical fibers 1942 has a light input portion 1942a and a light output portion 1942b. The light input portions 1942a are accommodated in the first housing 11 and are optically coupled to the light source 192. The light output portions 1942 are accommodated in the second housing 13 and are optically coupled to the light guide plate 196. In particular, light emitted by the light sources 192 is received and transmitted through the optical fibers 1942 to be outputted from the light output portions 1942b of the optical fibers 1942.

As mentioned above, one end of each of the light input portions 1942a is disposed opposite and faces toward each of the LEDs. Therefore, the end surfaces of the light input portions 1942a can be used to receive light emitted from the LEDs. In the present embodiment, numbers of optical fibers 1942 correspond to numbers of light sources 192. That is, the numbers of optical fibers 1942 and light sources 192 should be equal.

Furthermore, in order to increase the light utilization efficiency of the optical fibers 1942, the portable electronic device 10 in the present embodiment further includes reflection covers (not shown in FIG. 1) disposed in the first housing 11. The reflection covers surround the light source 192 and reflect and collect the light emitted by the light sources 192. In such case, numbers of reflection covers correspond to the numbers of light sources 192. In addition, the portable electronic device 10 in the present embodiment further can include converging lenses (not shown in FIG. 1) disposed between the light sources 192 and the end surfaces of the light input portions 1942a. In this way, the light utilization efficiency of the optical fibers 1942 can be further improved.

The light output portions 1942b of the optical fibers 1942 output the light transmitted by the optical fibers 1942 to the light guide plate 196. The light guide plate 196 has a light output surface 1962 and at least one light input surface 1964. The light output surface 1962 faces toward the display panel 17. The light input surface 1964 is adjacent to the light output surface 1962. For example, the light guide plate 196 has two light input surfaces 1964 disposed on opposite sides and the light input surfaces 1964 substantially perpendicularly adjoin to the light output surface 1962, as shown in FIG. 1. In particular, the light output portions 1942b of the optical fibers 1942 face towards the light input surfaces 1964 so that the optical fibers 1942 are optically coupled to the light guide plate 196. That is, light is outputted from the optical fiber 1942 and is incident onto the light input surfaces 1964 of the light guide plate 196. Light is then guided to emit from the light output surface 1962 of the light guide plate 196. In such case, the light guide plate 196 can be parallelepiped-shaped (as shown in FIG. 1) or wedge-shaped.

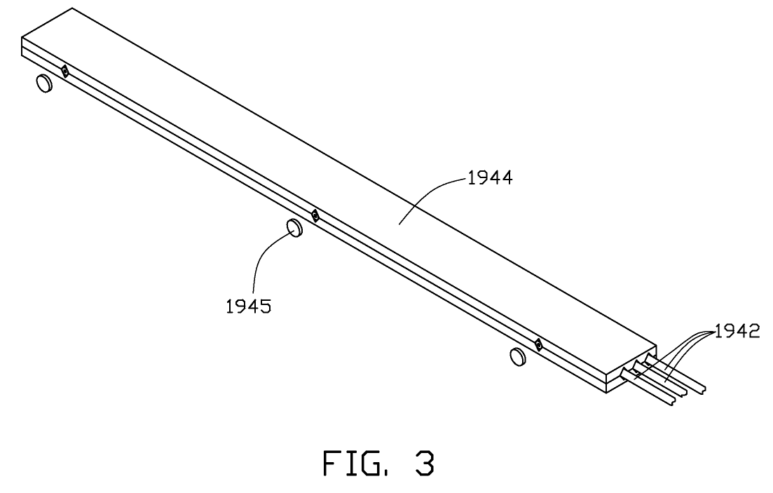

The light output portions 1942b of the optical fiber 1942 is fastened by the retaining element 1944, which is disposed in the second housing 13. Referring to FIG. 2 and FIG. 3, the retaining element 1944 includes a first retention portion 1944a and a second retention portion 1944b. The first retention portion 1944a and the second retention portion 1944b are attached to each other. The first retention portion 1944a and the second retention portion 1944b cooperatively define a plurality of grooves 1943 therein. The grooves 2943 accommodate the light output portions 1942b of the optical fibers 1942. The grooves 1943 defined on the first retention portion 1944a and the second retention portion 1944b are disposed opposite to form an accommodating space, when the first retention portion 1944a and the second retention portion 1944b are attached to each other, as shown in FIG. 3. Thus, the light output portions 1942b of the optical fibers 1942 can be received in the accommodating space. In addition, the grooves 1943 pass through the adjacent sides of the retaining element 1944 so that the light output portions 1942b accommodated in the grooves 1943 are forced to face the light guide plate 196. In the present embodiment, the grooves 1943 can be V-shaped grooves (as shown in FIG. 2) or U-shaped grooves.

In addition, in order to increase the light utilization efficiency of the optical fibers 1942, an end of each of the light output portions 1942b has a surface treated by a grinding process or a fusing process. Moreover, referring to FIG. 3, the portable electronic device 10 also can include converging lenses 1945 disposed adjacent to one side of the retaining element 1944. In particular, the converging lenses 1945 are disposed between the light output portions 1942b of the optical fibers 1942 and the optical input surfaces 1964 of the light guide plate 196 to increase the light utilization efficiency. In the present embodiment, the converging lenses 1945 disposed corresponding to the light output portions 1942b of the optical fibers 1942. That is, numbers of the converging lenses 1945 and numbers of the optical fibers 1942 should be equal.

As mentioned above, by way of disposing the light sources 192 with high luminance in the first housing 11 of the portable electronic device 10, the heat generated from the light sources 192 can be more easily on dissipated through the heat dissipating element 114 mounted on the motherboard 112. In addition, this configuration eliminates the need to arrange light sources 192 in the second housing 13, i.e. the LCD panel. Thus, heat generated in the second housing 13 could be significantly reduced. Moreover, the heat is dissipated more rapidly because the first housing 11 provides relative larger dissipating space. Thus, the heat is dissipated effectively so that the performance of the portable electronic device 10 can be improved.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A portable electronic device, comprising:
a first housing having a heat dissipating device therein;
a second housing pivoted to the first housing;
a display panel accommodated in the second housing; and
a backlight module comprising a light source, a light guide plate and an optical fiber assembly, the light source being disposed in the first housing, the light guide plate being disposed in the second housing, the optical fiber assembly comprising a plurality of optical fibers interconnecting the light source and the light guide plate.

2. The portable electronic device as claimed in claim 1, wherein the optical fibers each comprise a light input portion and a light output portion, the light input portions being optically coupled to the light source, the light output portions being optically coupled to the light guide plate.

3. The portable electronic device as claimed in claim 2, wherein the light guide plate comprises at least one light input surface and a light output surface, the light input surface facing toward the light output portions of the optical fibers, the light output surface facing toward the display panel.

4. The portable electronic device as claimed in claim 3, further comprising at least one converging lens disposed between the light output portions of the optical fibers and the optical input surface of the light guide plate.

5. The portable electronic device as claimed in claim 2, wherein the optical fiber assembly further comprises a retaining element retaining the optical fiber.

6. The portable electronic device as claimed in claim 5, wherein the retaining element is disposed in the second housing and retains the light output portions of the optical fibers.

7. The portable electronic device as claimed in claim 5, wherein the retaining element comprises a first retention portion and a second retention portion attached to each other, the first and the second retention portions cooperatively defining a plurality of grooves therein with the light output portions of the optical fibers received therein.

8. The portable electronic device as claimed in claim 7, wherein the grooves are V-shaped or U-shaped grooves.

9. The portable electronic device as claimed in claim 1, wherein the heat dissipating element disposed thermally contacts with the light source.

10. The portable electronic device as claimed in claim 1, wherein the light source includes a light emitting diode.

11. The portable electronic device as claimed in claim 1, wherein the display panel includes a liquid crystal display panel.

12. The portable electronic device as claimed in claim 1, wherein an end of the light output portion has a surface treated by a grinding process or a fusing process.

13. A portable electronic device comprising:
a display panel;
a light guide plate having a light input surface and a light output surface, the light output surface facing towards the display panel;
a plurality of point light sources; and
a plurality of optical fibers each having a first end optically coupled to the point light source and an opposite second end optically coupled to the light input surface of the light guide plate.

14. The portable electronic device as claimed in claim 13, wherein the light input surface substantially perpendicularly adjoining the light output surface.

15. The portable electronic device as claimed in claim 13, wherein the display panel is movable relative to the point light sources.
